(19) United States
(12) Patent Application Publication
(10) Pub. No.: US 2022/0328836 A1
(43) Pub. Date: Oct. 13, 2022

(54) ALL-SOLID-STATE BATTERY

(71) Applicant: TOYOTA JIDOSHA KABUSHIKI KAISHA, Toyota-shi (JP)

(72) Inventor: Hiroshi Tsubouchi, Tokyo (JP)

(21) Appl. No.: 17/675,187

(22) Filed: Feb. 18, 2022

(30) Foreign Application Priority Data
Mar. 2, 2021 (JP) 2021-032409

(51) Int. Cl. H01M 4/62; H01M 10/0585

(52) U.S. Cl. CPC H01M 4/621; H01M 10/0585; H01M 4/624; H01M 2004/027

(57) ABSTRACT

An all-solid-state battery capable of improving capacity retention thereof is provided. In the all-solid-state battery having an anode active material layer, the anode active material layer contains an anode active material, a binder obtained from a material having a double bond, and a conductive material containing a material having a needle-like structure, 5 vol % to 20 vol % of the anode active material layer is the binder, and the ratio of the conductive material to the binder in terms of volume is 0.4 to 1.0.

### CROSS REFERENCE TO RELATED APPLICATION

This application claims priority to Japanese Patent Application No. 2021-032409 filed on Mar. 2, 2021, the entire contents of which are incorporated by reference herein.

### TECHNICAL FIELD

The present disclosure relates to an all-solid-state battery.

### BACKGROUND

An all-solid-state battery is provided with a cathode including a cathode active material layer, an anode including an anode active material layer, and a solid electrolyte layer disposed between them and containing a solid electrolyte.

Patent Literature 1 discloses an all-solid-state battery with a Si-containing active material as an anode active material.

Patent Literature 2 discloses that an electrode active material (vapor-grown carbon fiber)/conductive material composite containing an electrode active material and a conductive material, and SBR (styrene-butadiene rubber) as a dispersant thereof may be used.

Patent Literature 3 discloses an electrode for all-solid-state batteries which contains a vapor-grown carbon fiber.

Patent Literature 4 discloses that: SBR may be used as a binder; and a vapor-grown carbon fiber may be used as a conductive material.

### CITATION LIST

### Patent Literature

Patent Literature 1: JP 2017-112029 A

Patent Literature 2: JP 2013-135223 A

Patent Literature 3: JP 2020-507893 A

Patent Literature 4: JP 2020-177904 A

### SUMMARY

### Technical Problem

The above-identified conventional arts each disclosing that an anode active material layer contains a binder and/or a conductive material cause a problem of low capacity retention as a result of charge and discharge.

An object of the present disclosure is to provide an all-solid-state battery capable of improving capacity retention thereof.

### Solution to Problem

One aspect of the present disclosure for solving the above problem is an all-solid-state battery having an anode active material layer, wherein the anode active material layer contains an anode active material, a binder obtained from a material having a double bond, and a conductive material containing a material having a needle-like structure, 5 vol % to 20 vol % of the anode active material layer is the binder, and a ratio of the conductive material to the binder in terms of volume is 0.4 to 1.0.

### Advantageous Effects

The all-solid-state battery according to the present disclosure is capable of improving capacity retention thereof.

### BRIEF DESCRIPTION OF DRAWINGS

FIG. 1 explanatorily shows a layer structure of an all-solid-state battery 10.

### DETAILED DESCRIPTION

### 1. All-Solid-State Battery

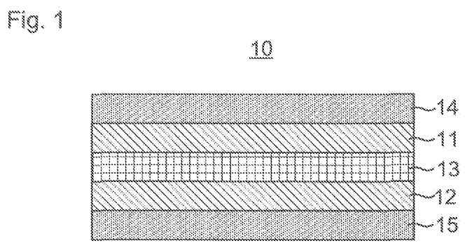

FIG. 1 shows a schematic cross-sectional view of one example of an all-solid-state battery 10 according to the present disclosure. As shown in FIG. 1, the all-solid-state battery 10 has a cathode active material layer 11 containing a cathode active material, an anode active material layer 12 containing an anode active material, a solid electrolyte layer 13 formed between the cathode active material layer 11 and the anode active material layer 12, a cathode current collector layer 14 configured to collect current of the cathode active material layer 11, and an anode current collector layer 15 configured to collect current of the anode active material layer 12.

The cathode active material layer 11 and the cathode current collector layer 14 may be called together a cathode. The anode active material layer 12 and the anode current collector layer 15 may be called together an anode.

Hereinafter each component of the all-solid-state battery 10 will be described.

1.1. Cathode Active Material Layer

The cathode active material layer 11 is a layer containing a cathode active material, and may further contain at least one of a solid electrolyte material, a conductive material and a binder if necessary.

Any known active material may be used as the cathode active material. Examples of the cathode active material include cobalt-based (such as LiCoO₂), nickel-based (such as LiNiO₂), manganese-based (such as LiMn₂O₄ and Li₂Mn₂O₃), iron phosphate-based (such as LiFePO₄ and Li₂FeP₂O₇), NCA-based (such as a compound of nickel, cobalt and aluminum), and NMC-based (such as a compound of nickel, manganese and cobalt) active materials, more specifically, LiNi_{1/3}Co_{1/3}Mn_{1/3}O₂.

The surface of the cathode active material may be coated with an oxide layer such as a lithium niobate layer, a lithium titanate layer and a lithium phosphate layer. The particle size of the cathode active material is not particularly limited, but for example, is in the range of 5 μm and 50 μm in some embodiments. Here, in this description, “particle size” means a particle diameter at a 50% integrated value (D₅₀) in a volume-based particle diameter distribution that is measured using a laser diffraction and scattering method.

For example, 50 wt % to 99 wt % of the cathode active material layer is the cathode active material.

In embodiments, the solid electrolyte is an inorganic solid electrolyte because the inorganic solid electrolyte has high ionic conductivity and is excellent in heat resistance, compared with the organic polymer electrolyte. Examples of the inorganic solid electrolyte include sulfide solid electrolytes and oxide solid electrolytes.

Examples of sulfide solid electrolyte materials having Li-ion conductivity include Li₂S—P₂S₅, Li₂S—P₂S₅—LiI, Li₂S—P₂S₅—U₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (m and n are positive numbers, and Z is any of Ge, Zn and Ga), Li₂S—GeS₂, Li₂S—SiS₂—Li₃PO₄, and Li₂S—SiS₂-LixMOy (x and y are positive numbers, and M is any of P, Si, Ge, B, Al, Ga and In). The expression “Li₂S—P₂S₅” means any sulfide solid electrolyte materials made with a raw material composition containing Li₂S and P₂S₅. The same is applied to the other expressions.

Examples of oxide solid electrolyte materials having Li-ion conductivity include compounds having a NASICON-like structure. Examples of compounds having a NASICON-like structure include compounds (LAGP) represented by the general formula Li₁₊ₓAlₓGe₂₋ₓ(PO₄)₃ (0≤x≤2), and compounds (LATP) represented by the general formula Li₁₊ₓAlₓTi₂₋ₓ(PO₄)₃ (0≤x≤2). Examples of other oxide solid electrolyte materials include LiLaTiO (such as Li_{0.34}La_{0.51}TiO₃), LiPON (such as Li_{2.9}PO_{3.3}NO_{4.6}) and LiLaZrO (such as Li₇La₃Zr₂O₁₂).

The content of the solid electrolyte in the cathode active material layer 11 is not particularly limited. For example, 1 wt % to 50 wt % of the cathode active material layer 11 is the solid electrolyte.

The binder is not particularly limited as long as being chemically and electrically stable. Examples of the binder include fluorine-based binders such as polyvinylidene fluoride (PVDF) and polytetrafluoroethylene (PTFE), rubber-based binders such as styrene-butadiene rubber (SBR), olefinic binders such as polypropylene (PP) and polyethylene (PE), and cellulose-based binders such as carboxymethyl cellulose (CMC).

The content of the binder in the cathode active material layer 11 is not particularly limited. For example, 0.1 wt % to 10 wt %. of the cathode active material layer 11 is the binder.

As the conductive material, a carbon material such as acetylene black (AB), Ketjenblack and carbon fibers, or a metallic material such as nickel, aluminum and stainless steel may be used.

The content of the conductive material in the cathode active material layer 11 is not particularly limited. For example, 0.1 wt % and 10 wt % of the cathode active material layer 11 is the conductive material.

In embodiments, the cathode active material layer 11 is in the form of a sheet from a viewpoint that the all-solid-state battery 10 can be easily formed. In this case, the thickness of the cathode active material layer 11 is, for example, 0.1 μm to 1 mm, and in some embodiments 1 μm to 150 μm.

1.2. Anode Active Material Layer

The anode active material layer 12 is a layer containing at least an anode active material, a binder and a conductive material, and may contain a solid electrolyte material if necessary. The solid electrolyte material may be considered in the same manner as for the cathode active material layer 11.

There is no particular limitation on the anode active material. When a lithium ion battery is formed, examples of the anode active material include carbon materials such as graphite and hard carbon, various oxides such as lithium titanate, Si and Si alloys, and metallic lithium and lithium alloys.

Among them, in the present disclosure, Si or a Si alloy may be used in embodiments. Si materials greatly expand and shrink according to charge and discharge, and thus offer a more outstanding effect of the present disclosure.

In this embodiment: the binder is obtained from a material having a double bond; and 5 vol % to 20 vol % of the anode active material layer 12 is this material.

Examples of the material having a double bond include styrene-butadiene rubber (SBR) and acrylonitrile-butadiene rubber (NBR).

In this embodiment: the conductive material is a material having a needle-like structure; and the ratio of the conductive material to the binder in terms of volume (the volume ratio of the conductive material/the volume ratio of the binder) in the anode active material layer 12 is set in 0.4 to 1.0.

Examples of the material having a needle-like structure include carbon fibers (CFs) and carbon nanotubes (CNTs).

Here, examples of “needle-like structure” include structures having a fiber diameter of at most 300 nm and a fiber length with respect to this fiber diameter (fiber length/fiber diameter: aspect ratio) of at least 40.

The anode active material layer having such a structure suppresses cracks generated in the anode active material (particularly between the anode active material and the solid electrolyte) even due to expansion and shrinkage thereof, which makes it possible to suppress decrease of the capacity due to isolation of the anode active material.

Specifically, the anode active material layer containing the binder and the conductive material at the above-identified ratio has well-balanced flexibility, electronic conductivity and ionic conductivity, so as to achieve both suppression of cracks, and conductivity.

It is considered that the use of the material having a needle-like structure as the conductive material can improve the strength of the anode active material layer because the material plays a role like a filler. It is also presumed that the use of the binder obtained from the material having a double bond as the binder can suppress cracks because the conductive material adsorbs the binder to form a more mechanically robust network.

The shape of the anode active material layer 12 may be the same as of conventional ones. In embodiments, the anode active material layer 12 is in the form of a sheet from a viewpoint that the all-solid-state battery 10 can be easily formed. In this case, the thickness of the anode active material layer 12 is, for example, 0.1 μm to 1 mm, and in some embodiments, 1 μm to 150 μm.

1.3. Solid Electrolyte Layer

The solid electrolyte layer 13 is a solid electrolyte layer disposed between the cathode active material layer 11 and the anode active material layer 12. The solid electrolyte layer 13 contains at least a solid electrolyte material. The solid electrolyte material may be considered in the same manner as the solid electrolyte material described for the cathode active material layer 11.

The solid electrolyte layer 13 may optionally contain a binder. The binder same as that used for the cathode active material layer 11 may be used. The content of the binder in the solid electrolyte layer is not particularly limited. For example, 0.1 wt % and 10 wt % of the solid electrolyte layer is the binder.

1.4. Current Collector Layers

The current collectors are the cathode current collector layer 14 configured to collect current of the cathode active material layer 11, and the anode current collector layer 15 configured to collect current of the anode active material layer 12. Examples of the material constituting the cathode current collector layer 14 include stainless steel, aluminum, nickel, iron, titanium and carbon. Examples of the material constituting the anode current collector layer 15 include stainless steel, copper, nickel and carbon.

The thicknesses of the cathode current collector layer 14 and the anode current collector layer 15 are not particularly limited, but may be suitably set according to a desired battery performance. For example, the thicknesses are each in the range of 0.1 μm to 1 μm.

1.5. Battery Case

The all-solid-state battery may be provided with a battery case that is not shown. The battery case is a case to house each member. An example of the battery case is a stainless battery case.

2. Effect etc.

The all-solid-state battery including the above-described anode active material layer suppresses cracks generated in the anode active material (particularly between the anode active material and the solid electrolyte) even due to expansion and shrinkage of the anode active material layer, which makes it possible to suppress decrease of the capacity due to isolation of the anode active material.

### 2. Method of Manufacturing all-Solid-State Battery

A method of manufacturing an all-solid-state battery will be hereinafter described. The method of manufacturing an all-solid-state battery may be carried out as known, but for example, can be carried out as follows.

[Preparing Cathode Structure]

The material to constitute the cathode active material layer is mixed and kneaded, and then the resultant slurry cathode composition is obtained. Thereafter a layer to be the cathode active material layer is formed on a surface of a material that is to be the cathode current collector layer by coating the surface with the prepared slurry cathode composition, thereafter via drying by heating. Pressure is applied to the resultant, to form a cathode structure having the layer to be the cathode current collector layer and the layer to be the cathode active material layer.

[Preparing Anode Structure]

The material to constitute the anode active material layer is mixed and kneaded, and then the resultant slurry anode composition is obtained. Thereafter, a layer to be the anode active material layer is formed on a surface of a material that is to be the anode current collector layer by coating the surface with the prepared slurry anode composition, thereafter via drying by heating. Pressure is applied to the resultant, to form an anode structure having the layer to be the anode current collector layer and the layer to be the anode active material layer.

[Preparing Solid Electrolyte Layer and all-Solid-State Battery]

The material to constitute the solid electrolyte layer is mixed and kneaded, and then the resultant slurry solid electrolyte composition is obtained. Thereafter a layer to be the solid electrolyte layer is formed on a surface of, for example, aluminum foil by coating the surface with the prepared slurry solid electrolyte composition, thereafter via drying by heating.

Then, the layer to be the solid electrolyte, and further the anode structure are transferred on the prepared cathode structure. Thus, the resultant all-solid-state battery can be prepared.

### 4. Examples

4.1. Preparing all-Solid-State Battery According to Each Example

### [Preparing Cathode Structure]

A cathode active material (LiNi_{0.33}Co_{0.33}Mn_{0.33}O₂) and a sulfide solid electrolyte (Li₂S—P₂S₅) were weighed so as to have a volume ratio of 75:25. To 100 parts by weight of the cathode active material, 1.5 parts by weight of a PVDF binder and 3.0 parts by weight of a conductive material (VGCF (trademark), SHOWA DENKO K.K.) were each weighed.

Next, they were blended so as to have a solid fraction of 63 wt %, and were mixed and kneaded for 1 minute using an ultrasonic homogenizer. Then, the resultant slurry cathode composition was prepared.

Thereafter a layer to be a cathode active material layer was formed on a surface of aluminum foil to be a cathode current collector layer by coating the surface with the slurry cathode composition, thereafter via drying by heating. The resultant was pressed at a linear pressure of 1 t/cm at 25° C., and then the resultant cathode structure having the layer to be a cathode current collector layer and the layer to be a cathode active material layer was prepared.

[Preparing Anode Structure]

An anode active material (Si) and a sulfide solid electrolyte (Li₂S—P₂S₅) were weighed so as to have a volume ratio of 60:40, to form a mixture. For this mixture, a binder and a conductive material were each weighed so as to have a volume ratio shown in Table 1. In Table 1: “SBR” in the binder means styrene-butadiene rubber and “PVDF” therein means polyvinylidene fluoride, and “CF” in the conductive material means a carbon fiber (in these examples, VGCF (trademark), SHOWA DENKO K.K. was used as CF. Among carbon fibers, VGCF (trademark) is referred to as a vapor-grown carbon fiber.) and “AB” therein means acetylene black.

Next, they were blended so as to have a solid fraction of 45 wt %, and were mixed and kneaded for 1 minute using an ultrasonic homogenizer. Then, the resultant slurry anode composition was prepared.

Thereafter a layer to be an anode active material layer was formed on a surface of nickel foil to be an anode current collector by coating the surface with the slurry anode composition, thereafter via drying by heating. The resultant was pressed at a linear pressure of 1 t/cm at 25° C., and then the resultant anode structure having the layer to be an anode current collector layer and the layer to be an anode active material layer was prepared.

[Preparing Solid Electrolyte Layer and all-Solid-State Battery]

A sulfide solid electrolyte (Li₂S—P₂S₅) and a PVDF binder were weighed, so that the PVDF binder was 1 part by weight to 100 parts by weight of the sulfide solid electrolyte.

Next, they were blended so as to have a solid fraction of 63 wt %, and were mixed and kneaded for 1 minute using an ultrasonic homogenizer. Then, the resultant slurry solid electrolyte composition was prepared.

Thereafter a layer to be a solid electrolyte layer was formed on a surface of aluminum foil by coating the surface with the slurry solid electrolyte composition, thereafter via drying by heating. The layer to be a solid electrolyte, and further the anode structure were further transferred on the cathode structure. Thus, the resultant all-solid-state battery was prepared.

4.2. Evaluation

The prepared all-solid-state battery was charged and discharged at 500 cycles in the conditions of: 2.5-4.2 V, 0.1 C CCCV. The capacity retention was calculated from a change between the discharge capacities at the first cycle and at the 500th cycle. The capacity retention of Comparative Example 1 was defined as 1. Based on this, the ratio of the capacity retention of each example was obtained.

4.3. Results

Table 1 shows the major conditions for and results of each example.

TABLE 1

| | Anode active material layer | | | | |
|---|---|---|---|---|---|
| | Binder | | Conductive material | | Result |
| | | Ratio of | | Volume ratio | Ratio of |
| | | content | | of conductive | capacity |
| | Material | vol % | Material | material/binder | retention |
| Comparative | SBR | 2 | CF | 0.8 | 1.000 |
| Example 1 | | | | | |
| Example 1 | SBR | 5 | CF | 0.8 | 1.087 |
| Comparative | SBR | 10 | CF | 0.2 | 1.029 |
| Example 2 | | | | | |
| Example 2 | SBR | 10 | CF | 0.4 | 1.101 |
| Example 3 | SBR | 10 | CF | 0.8 | 1.130 |
| Example 4 | SBR | 10 | CF | 1.0 | 1.087 |
| Comparative | SBR | 10 | CF | 1.2 | 1.014 |
| Example 3 | | | | | |
| Example 5 | SBR | 20 | CF | 0.8 | 1.116 |
| Comparative | SBR | 30 | CF | 0.8 | 0.942 |
| Example 4 | | | | | |
| Comparative | PVDF | 10 | CF | 0.2 | 1.014 |
| Example 5 | | | | | |
| Comparative | PVDF | 10 | CF | 0.4 | 1.022 |
| Example 6 | | | | | |
| Comparative | PVDF | 10 | CF | 0.8 | 1.029 |
| Example 7 | | | | | |
| Comparative | PVDF | 10 | CF | 1.2 | 1.007 |
| Example 8 | | | | | |
| Comparative | SBR | 10 | AB | 0.2 | 1.007 |
| Example 9 | | | | | |
| Comparative | SBR | 10 | AB | 0.4 | 1.003 |
| Example 10 | | | | | |
| Comparative | SBR | 10 | AB | 0.8 | 1.000 |
| Example 11 | | | | | |
| Comparative | SBR | 10 | AB | 1.2 | 0.993 |
| Example 12 | | | | | |

As can be seen from Table 1, the above-described anode active material layer, that is, an anode active material layer containing a binder obtained from a material having a double bond, and a conductive material containing a material having a needle-like structure, the binder being 5 vol % to 20 vol % of the anode active material layer, the ratio of the conductive material to the binder in terms of volume being 0.4 to 1.0 could increase the ratio of the capacity retention by at least 8% more than Comparative Example 1.

In contrast, the ratio of the capacity retention could not increase by at least 3% in the example that did not satisfy the requirement of the ratio of the contents of the binder and the conductive material (Comparative Examples 1 to 4), the example where PVDF, which is obtained from a material having no double bond, was used as the binder (Comparative Examples 5 to 8), and the example where AB, which has a spherical structure, was used as the conductive material (Comparative Examples 9 to 12).

### REFERENCE SIGNS LIST

10 all-solid-state battery
11 cathode active material layer
12 anode active material layer
13 solid electrolyte layer
14 cathode current collector layer
15 anode current collector layer

What is claimed is:

1. An all-solid-state battery having an anode active material layer, wherein
the anode active material layer contains an anode active material, a binder obtained from a material having a double bond, and a conductive material containing a material having a needle-like structure,
5 vol % to 20 vol % of the anode active material layer is the binder, and
a ratio of the conductive material to the binder in terms of volume is 0.4 to 1.0.
